(19) United States
(12) Patent Application Publication
(10) Pub. No.: US 2003/0123538 A1
(43) Pub. Date: Jul. 3, 2003

(54) Video recording and encoding in devices with limited processing capabilities

(76) Inventors: Michael Krause, Steudal (DE); Jim Rasmusson, Vellinge (SE)

Correspondence Address: JENKENS & GILCHRIST, 3200 Fountain Place, 1445 Ross Avenue, Dallas, TX, 75202-2799, US

(21) Appl. No.: 10/322,014

(22) Filed: Dec. 17, 2002

Related U.S. Application Data
(60) Provisional application No. 60/345,175, filed on Dec. 21, 2001.

(51) Int. Cl. H04N 7/18; H04N 7/12

(52) U.S. Cl. 375/240.01; 348/65; 375/240.12

(57) ABSTRACT

Method and system are disclosed for processing and encoding video data. The method and system use less computational complexity while maintaining substantially the same high level of quality as existing real-time encoders. In accordance with the invention, the encoding process is divided into two stages: a low complexity processing stage, and a high complexity processing stage. The low complexity processing stage can be performed in real-time by devices with limited processing capability. The high complexity processing stage is performed in non-real-time and, therefore, can also be performed by devices with limited processing capability.

### PRIOR RELATED APPLICATIONS

This application claims priority to, and hereby incorporates, U.S. Provisional Application serial No. 60/345,175, entitled “Video Recording and Encoding with Limited Processing Capabilities,” which was filed in the U.S. Patent and Trademark Office on Dec. 21, 2001.

### BACKGROUND OF THE INVENTION

1. Field of the Invention

The present invention relates to video processing and encoding and, in particular, to video processing and encoding in devices with limited processing capabilities.

2. Description of the Related Art

New and recently developed mobile communication systems have an increased amount of transmission bandwidth available to them. For example, the Universal Mobile Telecommunication System (UMTS), Wideband Code Division Multiple Access (WCDMA), Global System for Mobile Communication (GSM), and the like, all have higher available bandwidths compared to earlier systems. The increased transmission bandwidth makes possible a number of new applications in these systems. One of the most interesting and exciting of the new applications is recording and transmitting of digital video data.

In spite of the increased transmission bandwidth, the amount of data contained in a digital video is still much too large to be transmitted without some kind of compression. Compression is usually performed by an encoder. The encoder can be implemented as either hardware, software, or a combination of both. Presently existing encoders generally comply with one or more well known international standards for video encoding, for example, MPEG and H.26x.

FIG. 1 illustrates a functional block diagram of an exemplary encoder 100. The encoder 100 is a software implemented encoder. Raw video data, comprising of a sequence of still pictures or frames, are provided to the encoder 100. The frames are typically provided at a rate of 15 frames per second in order to achieve a high level of quality. Each frame is divided into blocks of 16×16 pixels. Within the encoder 100, the frames of raw video data are provided to a discrete cosine-transform (DCT) function 102. The DCT function 102 transforms the frames from the time domain into the frequency domain, with each frame represented by a set of DCT coefficients. Video compression is then achieved by quantization of the DCT coefficients via a quantization function 104.

The quantization function 104 also analyzes each frame to determine the frame coding type. There are generally three frame coding types: intra-frames (I-frames), predictive-frames (P-frames), and bi-directional predictive-frames (B-frames). Depending on the frame coding type, different processing is applied to each type of frames. For I-frames, only DCT and quantization are applied. P-frames and B-frames, on the other hand, are analyzed to remove redundancy in addition to DCT and quantization. For P-frames and B-frames, a dequantization function 106 and an inverse DCT (IDCT) function 108 are used to restore the transformed and quantized frames.

After dequantization and IDCT, a motion estimation and compensation function 110 looks for any changes in these frame relative to the previous and/or subsequent frames that may indicate the presence of motion. Motion vectors are then generated to describe any motion that may be detected. The motion vectors are subsequently stored for each frame, and a motion compensated frame is generated by the motion estimation and compensation function 110. This motion compensated frame is subtracted from the next frame at a summing node 112. The result of the subtraction is transformed into the frequency domain by the DCT function 102, and quantized by the quantization function 104. Because this frame now (theoretically) contains only the difference between it and the next frame, only a few non-zero DCT coefficients are left. The quantized coefficients, along with the motion vectors, are provided to an entropy encoder 114. The entropy encoder 114 encodes the DCT coefficients and the motion vectors to form, for example, an MPEG or H.26x compatible bit stream. The result is an extremely compressed, high quality video.

In presently existing software encoders, the entire encoding process is performed in real-time. That is to say, the DCT, quantization, motion estimation, motion compensation, and other functions are performed while the raw video data is being received. Because typically these functions are extremely complex and time-consuming, existing encoders require large amounts of data processing capability (e.g., memory space, processing speed). Using existing encoders in a mobile application such as a mobile terminal presents a problem, however, because the processing capability of the mobile terminal is limited. Video sequences would have to be recorded using only these limited resources and sufficient compression together with suitable quality must be guaranteed as well. Thus, full software implementation of such an encoder cannot be done in real-time in a mobile terminal. Hardware encoders are available, but existing hardware encoders significantly raise the cost of the mobile terminals and take up valuable extra physical space therein.

Accordingly, it is desirable to provide a system and method of video processing and encoding that requires less computational complexity than existing solutions while maintaining substantially the same high level of quality. In particular, it is desirable to be able to implement, for example, an MPEG and/or H.26x compliant encoder in devices with limited processing capability such as mobile terminals.

### SUMMARY OF THE INVENTION

The present invention overcomes the above limitations by providing processing and encoding of video sequences using less computational complexity while maintaining substantially the same high level of quality as existing real-time software encoders. In accordance with the present invention, the encoding process is divided into two stages: a low complexity processing stage, and a high complexity processing stage. The low complexity processing stage allows the encoding process to be performed in real-time by devices with limited processing capability. The high complexity processing stage is performed in non-real-time and, therefore, can also be performed by devices with limited processing capability.

The encoder of the present invention allows processing and encoding of, for example, MPEG and/or H.26x compatible videos, and is well suited for use in an environment with slow CPUs, such as a mobile environment. The invention allows the slow CPUs to perform both, real-time video recording and complex video encoding. In addition, since the invention uses a lossless difference-coding scheme in its real-time, low-complexity stage, video quality and compression rate are not significantly influenced compared to standard encoders. Furthermore, several encoding parameters can be directly derived from the real-time, low complexity processing stage, which allows for reduction in complexity and speeding up of the encoding process in the high-complexity stage.

### BRIEF DESCRIPTION OF THE DRAWINGS

A more complete understanding of the invention may be had by reference to the following detailed description when taken in conjunction with the accompanying drawings, wherein:

FIG. 1 is functional block diagram of a prior art encoder;

FIG. 2 is a functional block diagram of an encoder according to embodiments of the invention;

FIG. 3 is a functional block diagram of a prior art encoder that has been modified for use in the encoder of FIG. 2; and

FIG. 4 is a functional block diagram of a mobile terminal according to embodiments of the invention.

### DETAILED DESCRIPTION OF THE INVENTION

Following is a detailed description of the invention wherein reference numerals designating the same and similar elements are carried forward throughout the various figures.

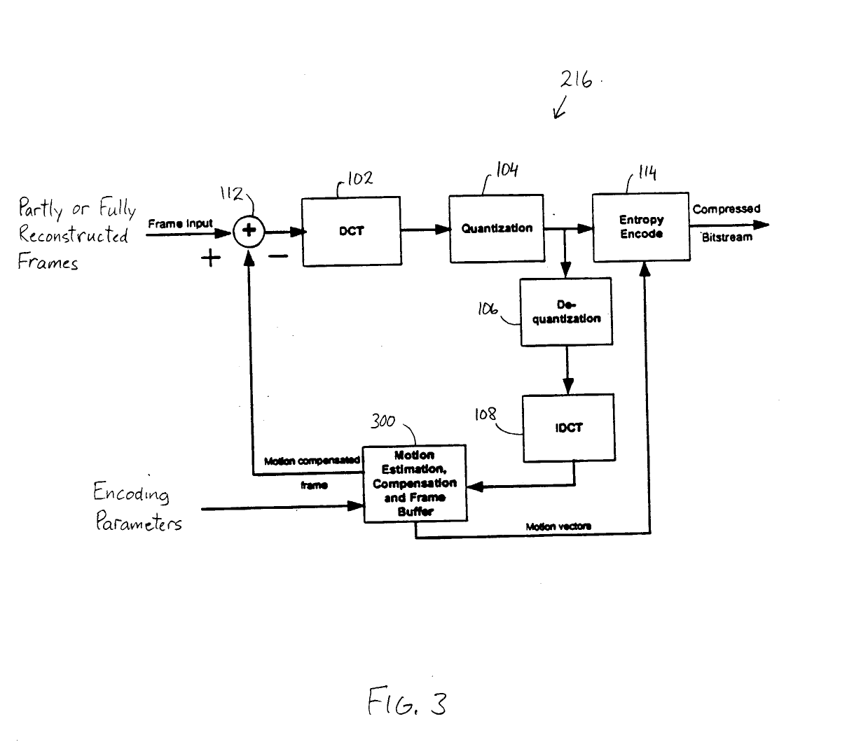

Referring now to FIG. 2, a functional block diagram of an encoder 200 according to embodiments of the invention is shown. The encoder 200 is a software encoder, although it can certainly be implemented as hardware or a combination of software and hardware by one having ordinary skill in this art. Moreover, while the encoder 200 is an MPEG and/or H.26x compliant encoder, other encoding standards may certainly be used. In accordance with embodiments of the invention, the encoder 200 is divided into a first encoder stage 202 and a second encoder stage 204. The first encoder stage 202 is a low complexity, real-time processing stage. The second encoder stage 204 is a high complexity, non-real-time processing stage.

In the first encoder stage 202, an initial compression is performed on the stream of raw video data to be encoded. This initial compression takes place in real-time, that is, as the video data is being received. The compression performed by the first encoder stage 202 reduces the volume of the data to facilitate the subsequent, non-real-time processing of the video data. Such a compression can be accomplished using any low complexity encoding scheme.

Low complexity encoding schemes are a type of encoding scheme that allows compression to be performed in real-time without requiring a large amount of processing capability. in some embodiments, the low complexity encoding scheme is preferably a difference-encoding scheme. A difference-encoding scheme, briefly, is one that makes use of the difference between the previous frame of video data and the current frame. Such an encoding scheme takes advantage of similarities between neighboring frames to reduce the data associated with each frame.

In accordance with embodiments of the invention, a stream of raw video data 204 to be encoded is tapped and temporarily stored in a frame buffer 206. The data stored in the frame buffer 206 is delayed by one frame then subtracted from the stream of raw video data at a summing node 208. More specifically, each frame of video data in the frame buffer 206 is subtracted from the immediately following frame in the stream of raw video data. The resulting difference-frame is provided to a difference-encoder 210.

The difference-encoder 210 uses a low complexity encoding scheme (such as a difference encoding scheme) to encode the difference-frames. Low complexity encoding is used because often there are not many differences between neighboring frames within a video sequence. This is especially true for certain types of videos such as news reporting where usually one person is speaking in the foreground while the background remains unchanged. The many similarities between neighboring frames means that the difference-frame contains many “zero” pixels. These zero pixels allow the difference-encoder 210 to efficiently encode the frame using a low complexity encoding scheme such as a run-length encoder or a Huffman encoder. Such encoders make use of the high level of redundancy between frames to encode the frame with a minimal amount of computations. In some embodiments, the difference-encoder 210 is a lossless encoder, which means that the encoded difference-frames can be exactly reconstructed. The encoded difference-frames are then provided to a sequence storage 212 for storage.

In addition to facilitating data compression, a difference-coding scheme allows simple deriving of several encoding parameters. For example, only the non-zero parts of a frame are interesting for motion estimation and compensation. These areas form regions of interest (ROI), which is one of the parameters used for motion estimation. Thus, a simple method of identifying the various ROI is by examining the difference-frame for areas that are non-zero. For example, if a given region (e.g., a block) in the frame contains more than a certain number of non-zero bits, then that area may be identified as an ROI.

Furthermore, the frame coding type of each frame can be defined using the difference-frame. For example, in a typical news speaker scene, there are only a few changes within neighboring frames. Therefore, most of the difference-frame will contain zeroes. Motion estimation can then be used for the non-zero parts. Such a frame will be coded as a P-frame. If a scene change occurs, the difference-frame will show almost no similarities and will have just a few zeroes. Motion estimation will not be as useful in these frames. Hence, these frames will be coded as I-frames in the encoder. Thus, a simple method of identifying the frame encoding type is by looking at the number of non-zero bits of the difference-frame. For example, if the total number of non-zero bits falls within certain predefined ranges, then the frame coding type is either I-frame, P-frame, or B-frame.

Once the stream of raw video data has been compressed and stored by the first stage encoder 202, the compressed video data is provided to the second encoder stage 204. The second encoder stage 204 is configured to generate, for example, an MPEG and/or H.26x compliant bit stream. As such, the second encoder stage 204 must perform a number of high complexity functions such as DCT, quantization, motion estimation, and motion compensation. In accordance with the invention, these high complexity functions are not performed in real-time, since the original video data has already been compressed and stored. Non-real-time performance of these high complexity functions allows them to be performed at a slower speed than in real-time. As such, a much smaller amount of processing capability is required. Consequently, the functions may be implemented in devices with limited processing capabilities, such as mobile terminals.

Referring still to FIG. 2, the encoded difference-frames from the first encoder stage 202 are read from the sequence storage 212. These difference-frames are then provided to a decode and analysis section 214. The decode and analysis section 214 decodes the encoded difference-frames, then analyzes the decoded difference-frames for information regarding the frame coding type and/or ROI. Decoding is performed by applying the inverse of the encoding process (e.g., Huffman, run-length) to the encoded difference-frames. The encoding information will then be used in a subsequent non-real-time encoding process. Note that although the described functions are combined into one functional block here, in other embodiments, they may be divided into two or more functional blocks without departing from the scope of the invention.

Analysis of the decoded difference-frames is performed by examining the nonzero areas of the difference-frame in the manner described above. For example, if a given region (e.g., a block) in the difference-frame contains more than a certain number of non-zero bits, then that area may be identified as an ROI. In addition, if the total number of non-zero bits falls within certain predefined ranges, then the frame coding type is either I-frame, P-frame, or B-frame. In this manner, various encoding parameters may be derived from the decoded difference-frames.

The encoding parameters suggest whether the decode and analysis section 214 should reconstruct the original frames from the difference frames. For example, where the encoding parameters indicate there is motion present in a frame, the decode and analysis section 214 should reconstruct the original frame. Preferably, only the portion of the original frame corresponding to a ROI is reconstructed, as motion compensation is needed only with respect to this portion. The rest of the original frame need not be reconstructed. Thus, the frame will contain a portion of the original frame and a portion of the difference-frame. The partial reconstruction helps reduce the processing burden on the overall encoding process, as will be explained later below. Where the encoding parameters indicate most or all of the frame contains motion (e.g., during a scene change), the decode and analysis section 214 should reconstruct the full original frame. Where the encoding parameters indicate there is no motion in the frame, the full difference-frame is kept (i.e., no reconstruction of the original frame).

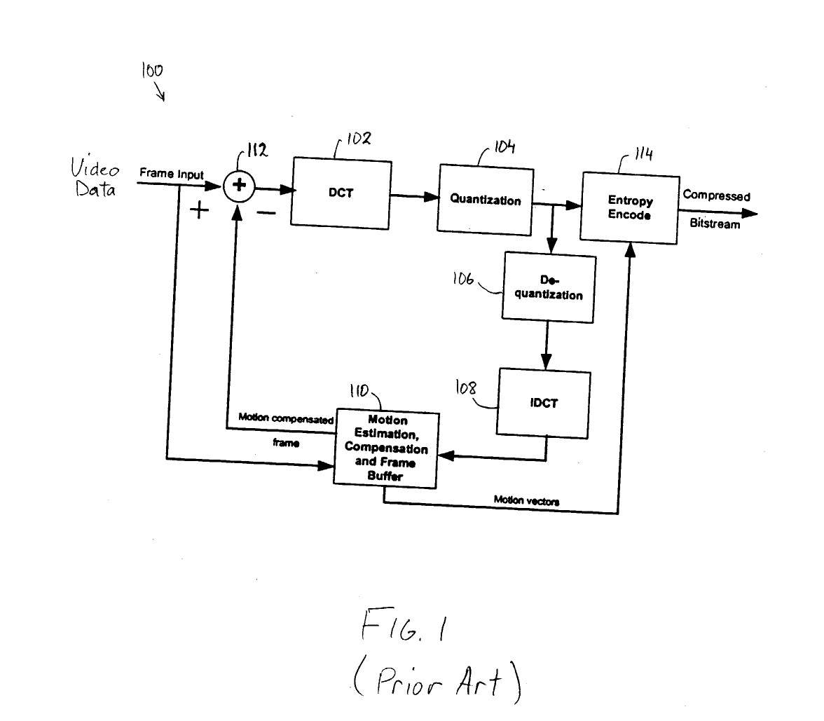

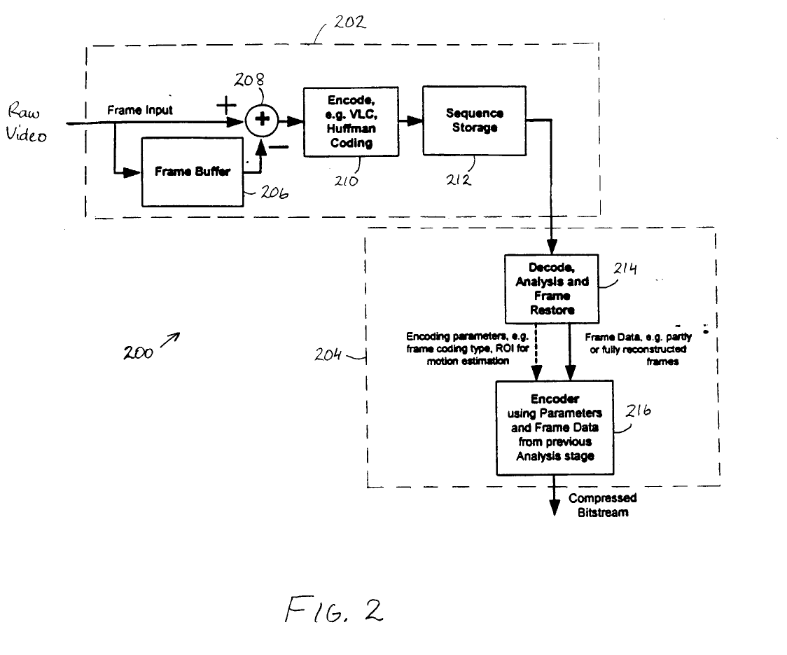

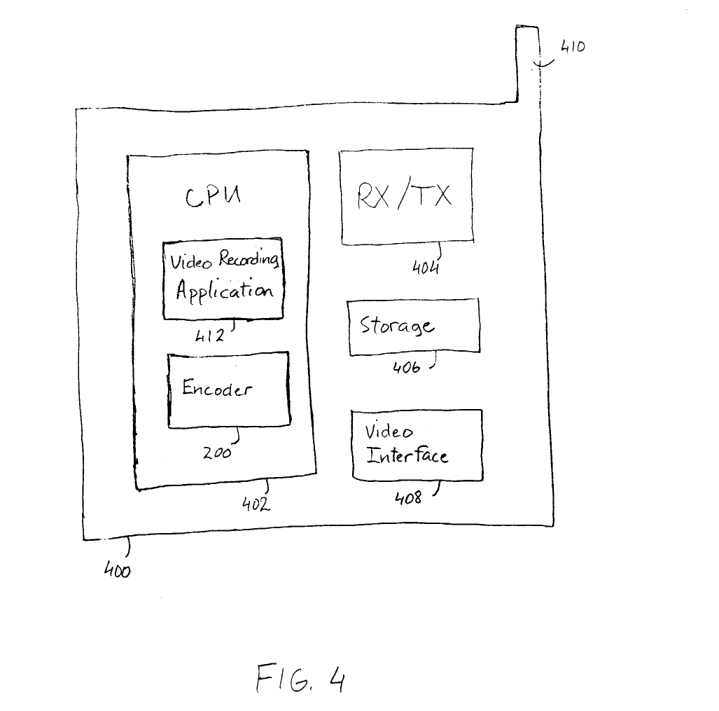

Once the difference-frames have been analyzed and the encoding parameters derived, then the frames and the encoding parameters are provided to an encoder 216. Depending on the indications of the encoding parameters, the frames are provided to the encoder 216 as either fully reconstructed original frames of the raw video data, full difference-frames, and/or partly reconstructed original frames. FIG. 3 illustrates the functional components of the encoder 216. In some embodiment, the encoder 216 is an MPEG and/or H.26x compatible encoder, although other standards may certain be used. The functional components of the encoder 216 perform substantially the same functions as the prior art encoder 100 shown in FIG. 1. The main distinction, however, is that the encoder 216 is operated in non-real-time and, therefore, requires a smaller amount of processing capability. The encoder 216 is also compatible with other encoding formats in addition to MPEG.

Another distinction is that the encoder 216 of the invention receives and uses difference frames and the derived encoding parameters instead of raw video data for encoding and for motion compensation. To this end, the encoder 216 has been modified somewhat from the prior art encoder 100, resulting in a smaller amount of processing capability being required. In particular, the encoder 216 includes a modified motion estimation and compensation function 300 that is capable of receiving and using encoding parameters instead of raw video data to perform motion compensation, and that is also capable of performing motion compensation on partly reconstructed original frames. The details of such modification are well within the ability of those having ordinary skill in this art and will therefore not be described here. In frames without any motion based on the encoding parameters, only DCT and quantization need to be applied to these frames (i.e., no motion estimation or compensation). Little or no change is anticipated for the DCT and quantization functions in the encoder 216.

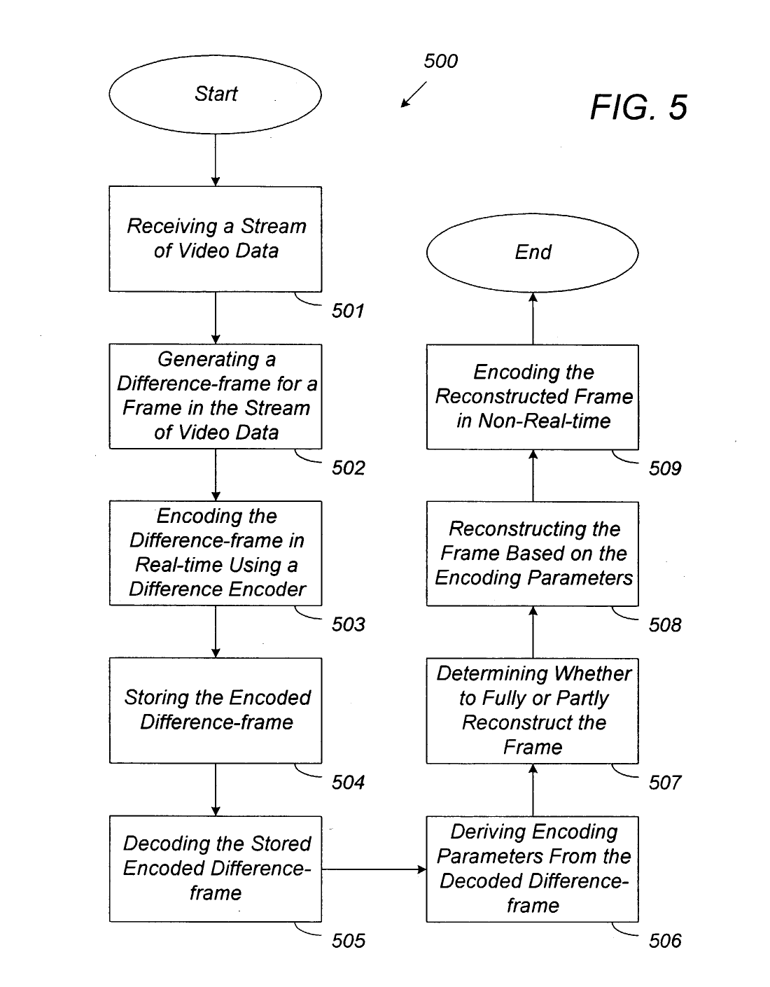

FIG. 4 illustrates an exemplary device 400 that may be used to implement the encoder 200 according to embodiments of the invention. The device 400 may be any device with limited processing capability, such as a mobile terminal, a personal digital assistant (PDA), and the like. As can be seen, the device 400 has a number of functional components, including at least a CPU 402, a transceiver 404, and a storage unit 406. These components are generally well known and will be mentioned only briefly here. The CPU 402 is responsible for the overall operation of the mobile device 400 and controls the functions of the other components. The transceiver 404 allows the mobile device 400 to send and receive communication over a medium such as a radio link. The storage unit 406 provides temporary and long term storage for any data and/or software programs used by the device 400, The device 400 preferably also has a video data interface 408 (e.g., an IEEE 1394 port) that is capable of receiving raw video data from, for example, an attached video camera (not shown). Where applicable, the device 400 may also include an antenna 410 for use in connection with the transceiver 404.

The CPU 402 typically has a number of software programs executing thereon, including at least an operating system (not shown). In addition, the CPU 402 may also have the encoder 200 of the invention executing thereon, as well as a video recording application 412. The video recording application 412 allows a user to record (and playback) videos and pictures using the device 400 and the encoder 200 therein. In some embodiments, the video recording application 412 supports the Multimedia Messaging Servicem (MMS) format. An MMS message can contain any combination of graphics, photographic imagery, and audio. The encoder 200, as already mentioned above, may be an MPEG and/or H.26x compliant encoder, for example.

In operation, the video recording application 412 provides a graphical user interface (GUI) that can be used for selecting the particular video application. The user can select various application options using a simple pen, a small joystick, or other pointing device. For example, one of the options is MMS services and/or MMS video. The video recording application 412 also allows the user to select one of several quality modes, which determines the maximum recording time. In general, a longer video can be recorded by using lower quality.

Once the application and quality mode has been selected, the user can start recording the video. At this time, the low complexity, real-time part of the encoder 200 begins to compress the video input data. The data rate is controlled by the video recording application 412 based on whether the user has selected a fixed recording time. In order to guarantee high quality without skipping frames or changing quantization, however, it is contemplated that the best quality modes do not use rate control. The compressed file is then stored in the sequence storage unit (see FIG. 2). After the sequence storage unit is full, the video recording application process stops recording. The user may also manually stop the recording.

Afterward, in some embodiments, a statistics window appears indicating the sequence length, precompressed file size, and estimated file size after final encoding by the encoder 200. The estimated file size may be based on statistics, for example, from the file sizes of previous sequences. For example, a very simple, but not very exact way is to define a certain compression rate, say 50%, for a given quality mode. Then, the estimated final encoding file size will simply be half of the low complexity encoding file size when using that quality mode.

The user may then select one of several options from the video recording application 412, including video playback, final encoding and sending, selection of sequence parts, new video recording, and cancellation of MMS video encoding. At this stage, the advantages of low complexity encoding, in contrast to the prior art, becomes clear. For example, the previously compressed video data can be decoded and displayed using a standard decoder (e.g., MPEG-4), which is preferably included in the device 400. Furthermore, a video transcoder instead of another encoder can be used to finally encode the pre-compressed MPEG files. Note, however, that the final encoding process will take some time. Afterwards, another statistics window displays a summary, including for example the final file size, transmission costs, and approximate transmission time.

FIG. 5 illustrates a method 500 for encoding video data according embodiments of the invention. At step 501, a stream of video data is received by the encoder, and a difference-frame is generated for each frame in the stream of video data at step 502. The difference-frames are generated, for example, by buffering the stream of data, then subtracting a previous frame stored in the buffer from each current frame. Encoding of the difference-frames takes place in real-time at step 503. The difference encoder may be any low-complexity encoder, such as a Huffman encoder or a run-length encoder, that can be performed by a device with limited processing capability. Preferably, the difference encoder is a lossless encoder.

At step 504, the encoded difference-frames are stored. The stored and encoded difference frames are subsequently decoded at step 505 using the inverse of the difference encoder (e.g., Huffman, run-length). At step 506, one or more encoding parameters are derived based on the decoded difference-frames. A determination is made at step 507 as to whether the original frames should be partly or fully reconstructed for motion estimation and compensation, or not reconstructed at all, based on the encoding parameters. The frames are then reconstructed at step 508, based on the derived encoding parameters. At step 509, the reconstructed frames are encoded, including motion estimation and compensation, using a high-complexity, lossy encoding process that is, for example, MPEG and/or H.26x compatible. The high-complexity encoding process is performed in non-real-time and, therefore, may be performed by a device with limited processing capability.

Although a limited number of embodiments of the invention have been described, these embodiments are not intended to limit the scope of the invention as otherwise described and claimed herein. For example, while the invention has been described in terms of the encoding process, the invention is equally applicable to the decoding process. Thus, variations and modifications from the described embodiments exist. Accordingly, the appended claims are intended to cover all such variations and modifications as falling within the scope of the invention.

What is claimed is:

1. A method for processing and encoding video data in a device with limited processing capability, comprising:
receiving a stream of video data;
generating a difference-frame for a frame in said stream of video data;
encoding said difference-frame in real-time using a difference encoder;
storing said encoded difference-frame;
decoding said stored encoded difference-frame;
deriving one or more encoding parameters from said decoded difference-frame;
reconstructing an original frame based on said one or more encoding parameters; and
encoding said reconstructed frame in non-real-time.

2. The method according to claim 1, further comprising determining whether to fully or partly reconstruct said frame based on said one or more encoding parameters.

3. The method according to claim 1, wherein said step of generating a difference-frame includes buffering said stream of video data, and subtracting a buffered previous frame from said frame.

4. The method according to claim 1, wherein said step of encoding said difference-frame uses a low complexity lossless difference-encoder.

5. The method according to claim 1, wherein said step of deriving said one or more encoding parameters includes determining a total number of non-zero bits in said difference frame.

6. The method according to claim 1, wherein said step of deriving said one or more encoding parameters includes identifying non-zero regions in said difference frame.

7. The method according to claim 1, wherein said encoding parameters include regions of interest and a frame coding type.

8. The method according to claim 1, wherein said step of encoding said reconstructed frame uses a high-complexity lossy encoder.

9. The method according to claim 8, wherein said high-complexity lossy encoder produces a bitstream that is compatible with any international encoding standard.

10. The method according to claim 1, wherein said device with limited processing capability is a mobile terminal.

11. A system for processing and encoding video data in a device with limited processing capability, comprising:
a frame buffer configured to buffer a frame in a stream of video data;
a summing node adapted to generate a difference-frame for said frame;
a difference-encoder capable of encoding said difference-frame in real-time;
a sequence storage configured to store said encoded difference-frame;
a difference-decoder adapted to decode said stored encoded difference-frame;
a frame analyzer capable of deriving one or more encoding parameters from said decoded difference-frame;
a frame restorer configured to reconstruct an original frame based on said one or more encoding parameters; and
an encoder adapted to encode said reconstructed frame in non-real-time.

12. The system according to claim 11, wherein said framer restorer is further configured to determine whether to fully or partly reconstruct said frame based on said one or more encoding parameters.

13. The system according to claim 11, wherein said summing node is adapted to subtract a buffered previous frame from said frame.

14. The system according to claim 11, wherein said difference-encoder is a low complexity lossless difference-encoder.

15. The system according to claim 11, wherein said framer analyzer derives said one or more encoding parameters by determining a total number of non-zero bits in said difference frame.

16. The system according to claim 11, wherein said framer analyzer derives said one or more encoding parameters by identifying non-zero regions in said difference frame.

17. The system according to claim 11, wherein said encoding parameters include regions of interest and a frame coding type.

18. The system according to claim 11, wherein said frame encoder is a high-complexity lossy encoder.

19. The system according to claim 18, wherein said high-complexity lossy encoder produces a bitstream that is compatible with any international encoding standard.

20. The system according to claim 11, wherein said device with limited processing capability is a mobile terminal.
